(19) United States
(12) Patent Application Publication
(10) Pub. No.: US 2026/0209879 A1
(43) Pub. Date: Jul. 23, 2026

(54) COLD ROLLED AND COATED STEEL SHEET AND A METHOD OF MANUFACTURING THEREOF

(71) Applicant: ArcelorMittal, Luxembourg (LU)

(72) Inventors: Jean-Marc PIPARD, VAUX (FR); Pierre TARGY, JAULNY (FR); Marc Olivier THENOT, Malancourt-La-Montagne (FR)

(21) Appl. No.: 19/134,988

(22) PCT Filed: Dec. 9, 2022
(86) PCT No.: PCT/IB2022/061977

§ 371 Date: Jun. 2, 2025

(51) Int. Cl. C21D 9/46; B32B 15/01; C21D 1/18; C21D 1/84; C21D 6/00; C21D 8/0221; C21D 8/0247; C21D 8/0278; C22C 38/00; C22C 38/02; C22C 38/04; C22C 38/06; C22C 38/28; C22C 38/32; C22C 38/34; C22C 38/38

(52) U.S. Cl. CPC C21D 9/46; B32B 15/013; C21D 1/18; C21D 1/84; C21D 6/002; C21D 6/005; C21D 6/008; C21D 8/0226; C21D 8/0236; C21D 8/0263; C21D 8/0278; C22C 38/001; C22C 38/002; C22C 38/02; C22C 38/04; C22C 38/06; C22C 38/28; C22C 38/32; C22C 38/34; C22C 38/38; B32B 2250/02; B32B 2311/20; B32B 2311/30; C21D 2211/001; C21D 2211/002; C21D 2211/005; C21D 2211/008

(57) ABSTRACT

A cold rolled and coated steel sheet, the steel including, 0.15%≤carbon≤0.25%, 1.5%≤manganese≤2.5%, 1%≤silicon≤2%, 0%≤aluminum≤0.09%, 0.1%≤chromium≤0.6%, 0%≤phosphorus≤0.02%, 0%≤sulfur≤0.03%, 0%≤nitrogen≤0.09%, 0%≤molybdenum≤0.5%, 0.001%≤niobium≤0.09%, 0%≤titanium≤0.06%, 0%≤vanadium≤0.1%, 0%≤nickel≤1%, 0%≤Copper≤1%, 0%≤calcium≤0.005%, 0%≤boron≤0.010%, 0%≤Magnesium≤0.05%, 0%≤Zirconium≤0.05%, 0%≤Cerium≤0.1%, and the balance including iron and unavoidable impurities, the steel sheet having a microstructure including 35% to 70% of cumulative presence of Bainite and Partitioned Martensite, 9% to 15% of residual austenite, 12% to 38% of ferrite and 5% to 15% fresh martensite in area fractions.

The present invention relates to cold rolled and coated steel sheet which is suitable for use as a steel sheet for vehicles.

### BACKGROUND

Automotive parts are required to satisfy two inconsistent necessities, namely ease of forming and strength. However in recent years a third requirement of improvement in fuel consumption is also bestowed upon automobiles in view of global environment concerns. Thus, now automotive parts must be made of material having high formability in order that to fit in the criteria of ease of fit in the intricate automobile assembly and at same time have to improve strength for vehicle crashworthiness and durability while reducing weight of vehicle to improve fuel efficiency. Furthermore the steel part must be weldable while not suffering from liquid metal embrittlement.

### SUMMARY OF THE INVENTION

Therefore, intense Research and development endeavors have been undertaken are put in to reduce the amount of material utilized in vehicles by increasing the strength of material. Conversely, an increase in strength of steel sheets decreases formability, and thus development of materials having both high strength and high formability is necessitated.

Earlier research and developments in the field of high strength and high formability steel sheets have resulted in several methods for producing high strength and high formability steel sheets, some of which are enumerated herein for conclusive appreciation of the present invention:

EP3187608 is high-strength hot-dip galvanized steel sheet having a tensile strength (TS) of 1,300 MPa or more and excellent in ductility and in-plane uniformity of material properties is provided, and a method for manufacturing the steel sheet is also provided. The high-strength hot-dip galvanized steel sheet has a specific composition including C, Si, Mn, etc. In this chemical composition, the content of Ti [Ti] and the content of N [N] satisfy [Ti]>4 [N]. The high-strength hot-dip galvanized steel sheet has a microstructure including martensite at an area fraction of 60% or more and 90% or less, polygonal ferrite at an area fraction of more than 5% and 40% or less, and retained austenite at an area fraction of less than 3% (including 0%). The average hardness of the martensite is 450 or more and 600 or less in terms of Vickers hardness, and the average crystal grain diameter of the martensite is 10 μm or less. The standard deviation of the crystal grain diameters of the martensite is 4.0 μm or less. EP3187608 is able to provide the tensile strength above 980 MPa but does not have an elongation of 14% or more.

EP3473741 is a steel sheet having a tensile strength of 950 MPa or more and good toughness and a method for manufacturing the same. The steel sheet has a specific composition and a metallographic structure containing: a ferrite area fraction of 30% or less (including 0%), a tempered martensite area fraction of 70% or more (including 100%), and a retained austenite area fraction of 4.5% or less (including 0%), wherein the average aspect ratio of an iron based carbide, precipitated in tempered martensite grains, having a grain size in the largest 10% is 3.5 or more. But the steel of EP3473741 is not able to provide the ultimate tensile strength of 950 or more.

The known prior art related to the manufacture of high strength and high formability steel sheets is inflicted by one or the other lacuna: hence there lies a need for a cold rolled steel sheet having strength greater than 1000 MPa and a method of manufacturing the same.

It is an object of the present invention to provide a cold-rolled and coated steel sheets that simultaneously have:
an ultimate tensile strength from 1000 MPa to 1180 MPa and preferably from 1050 MPa to 1180 MPa,
a yield strength from 700 MPa to 850 MPa and preferably from 700 MPa to 840 MPa,
a hole expansion ratio of 20% or more and preferably 25% or more, and
a total elongation of 14% or more and preferably 15% or more.

The present invention provides a cold rolled and coated steel sheet, the steel comprising, in weight percentage,
0.15%≤carbon≤0.25%,
1.5%≤manganese≤2.5%,
1%≤silicon≤2%,
0%≤aluminum≤0.09%,
0.1%≤chromium≤0.6%,
0%≤phosphorus≤0.02%,
0%≤sulfur≤0.03%,
0%≤nitrogen≤0.09%,
and optionally one or more of the following elements
0%≤molybdenum≤0.5%,
0.001%≤niobium≤0.09%,
0%≤titanium≤0.06%,
0%≤vanadium≤0.1%,
0%≤nickel≤1%,
0%≤Copper≤1%,
0%≤calcium≤0.005%,
0%≤boron≤0.010%,
0%≤Magnesium≤0.05%,
0%≤Zirconium≤0.05%,
0%≤Cerium≤0.1%,
   and the balance including iron and unavoidable impurities, the steel sheet having a microstructure comprising of 35% to 70% of cumulative presence of Bainite and Partitioned Martensite, 9% to 15% of residual austenite, 12% to 38% of ferrite and 5% to 15% fresh martensite in area fractions.

The present invention also provides a method of manufacturing of a cold rolled and coated steel sheet comprising the following successive steps:
providing a steel composition as provided above to obtain a semi-finished product,
reheating said semi-finished product to a temperature above from 1000° C.;
rolling the said semi-finished product completely in the austenitic range wherein the hot rolling finishing temperature is greater than or equal to 850° C. to obtain a hot rolled steel sheet;
cooling the sheet at a cooling rate above 3° C./s to a temperature below or equal to 650° C.; and coiling the said hot rolled sheet at temperature of coiling below 650° C.;
cooling the said hot rolled sheet;
performing optional scale removal process on said hot rolled steel sheet;
subjecting the hot rolled steel sheet to an annealing at a temperature from 350° C. to 750° C. during 1 h to 96 h;
performing optional scale removal process on said hot rolled annealed steel sheet;
cold rolling the said hot rolled steel sheet with a reduction rate from 35 to 70% to obtain a cold rolled steel sheet;
then heating the said cold rolled steel sheet in two steps heating wherein:
   the first step of heating the cold rolled steel sheet starts from room temperature to a temperature HT1 from 575° C. to 770° C., with a heating rate HR1 of at least 10° C./s;
   the second step of heating starts from HT1 to a temperature Tsoak from 780 to 880° C., with a heating rate HR2 from 0.5° C./s to 50° C./s, where it is held during 100 to 1000 seconds
then cooling the said cold rolled steel sheet wherein:
   an optional first step of cooling the cold rolled steel sheet starts from Tsoak down to a temperature T1 from 680° C. to 820° C., with a cooling rate CR1 from 0.1° C./s to 15° C./s;
   a cooling step starts from T1 or Tsoak down to a temperature T2 from Ms−10° C. to 20° C., with a cooling rate CR2 of at least 15° C./s, the said cold rolled steel sheet may be optionally held at T2 from 1 second to 200 seconds
then heating the cold rolled steel sheet from T2 temperature to an overaging temperature TOA from 350° C. to 550° C. at an average heating rate HR3 from 1° C./s to 100° C./s,
then the said cold rolled steel sheet is overaged at TOA during 5 to 500 seconds,
then the cold rolled steel sheet is brought to coating temperature which is from 420° C. to 680° C. for coating the cold rolled steel sheet,
thereafter cooling the coated cold rolled steel sheet to room temperature to obtain a cold rolled and coated steel sheet.

In a preferred embodiment, the cold-rolled and coated steel sheet shows a YS/TS ratio greater than 0.6.

Preferably, such steel can also have a good suitability for forming, in particular for rolling with good weldability and coat ability.

Another object of the present invention is to make available a method for the manufacturing of these sheets that is compatible with conventional industrial applications while being robust towards manufacturing parameters shifts.

The cold rolled and coated steel sheet of the present invention is coated with zinc or zinc alloys, or with aluminum or aluminum alloys to improve its corrosion resistance.

### DETAILED DESCRIPTION

Other characteristics and advantages of the invention will become apparent from the following detailed description of the invention.

Carbon is present in the steel from 0.15% to 0.25%. Carbon is an element necessary for increasing the strength of a steel sheet by delaying the formation of ferrite and promoting bainite formation during cooling after annealing. Further carbon also plays a pivotal role in formation of partitioned martensite. A content less than 0.15% would not allow formation of adequate amount of bainite and partition martensite, thereby decreasing strength as well as ductility. On the other hand, at a carbon content exceeding 0.25%, a weld zone and a heat-affected zone are significantly hardened, and thus the mechanical properties of the weld zone are impaired. Preferable limit for carbon is from 0.17% to 0.23% and more preferred limit is from 0.18% to 0.21%.

Manganese content of the steel of the present invention is from 1.5% to 2.5%. Manganese is an element that imparts strength as well as stabilizes austenite to obtain residual austenite. An amount of at least 1.5% of manganese is necessary to provide the strength and hardenability of the steel sheet by delaying the formation of Ferrite as well as to stabilize austenite. Thus, a higher percentage of Manganese such as from 1.7% to 2.3% is preferred and more preferably from 2% to 2.3%. But when manganese is more than 2.5%, this produces adverse effects such as slowing down the transformation of austenite to bainite during the isothermal holding for bainite transformation, leading to a reduction of ductility. Additionally, when the manganese is above 2.5% not enough bainite is formed and the formation of fresh martensite is beyond the targeted limit thus elongation decreases. Moreover, a manganese content above 2.5% would cause central segregation and also reduce the weldability of the present steel.

Silicon content of the steel of the present invention is from 1% to 2%. Silicon as a constituent retards the precipitation of cementite precipitation in martensite. Additionally, silicon retards carbon precipitation as cementite in bainite during the soaking after cooling from high temperature. Thus, during formation of carbide free bainite austenite is enriched in carbon and therefore, due to the presence of 0.9% of silicon, Austenite is stabilized at room temperature. In both cases cementite in bainite or cementite in martensite are also responsible of elongation decrease. Preventing cementite formation by the presence of silicon is important however, adding more than 2% of silicon does not improve the mentioned effect and leads to problems such as hot rolling embrittlement as well as silicon more than 2% in the steel of the present invention makes Zn not soluble in the grains. So, when welding, liquid Zn goes along the grain boundaries, instead of going into the grains causing liquid metal embrittlement. Therefore, the concentration is controlled within an upper limit of 2%. Preferred limit for silicon for the present steel is from 1.1% to 1.9% and more preferably from 1.3% to 1.7%.

The content of aluminum of the steel of the present invention is from 0 to 0.09%. Aluminum is added during the steel making for deoxidizing the steel to trap oxygen. Higher than 0.09% will increase the Ac3 point, thereby lowering the productivity. Additionally, within such range, aluminum bounds nitrogen in the steel to form aluminum nitride to reduce the size of the grains and Aluminum also delays the precipitation of cementite, however when the content of aluminum exceeds 0.09% in the present invention, the amount and size of aluminum nitrides are detrimental to the hole expansion and bending and also pushes the Ac3 to a higher temperature ranges which are industrially very expensive to reach and also causes grain coarsening during annealing soaking. Preferable limit for aluminum is 0% to 0.06% and more preferably 0% to 0.05%.

Chromium is an essential element of the steel of the present invention. The Chromium content is from 0.1% to 0.6%. Chromium provides strength and hardening to the steel, but when the content is above 0.6%, it impairs the surface finish of the steel. The preferred limit for chromium is from 0.1% to 0.5% and more preferably from 0.1% to 0.4%.

Phosphorus content of the steel of the present invention is limited to 0.02%. Phosphorus is an element which hardens in solid solution. Therefore, a small amount of phosphorus, of at least 0.002% can be advantageous, but phosphorus has its adverse effects also, such as a reduction of the spot weldability and the hot ductility, particularly due to its tendency to segregation at the grain boundaries or co-segregation with manganese. For these reasons, its content is preferably limited to a maximum of 0.015%.

Sulfur is not an essential element but may be contained as an impurity in steel. The sulfur content is preferably as low as possible but is 0.03% or less and preferably at most 0.005%, from the viewpoint of manufacturing cost. Further if a higher sulfur content is present in steel, it combines to form sulfide especially with Mn and Ti which are detrimental for bending, hole expansion and elongation of the steel of the present invention.

Nitrogen is limited to 0.09% to avoid ageing of the material and to minimize the precipitation of nitrides during solidification which are detrimental for mechanical properties of the Steel.

Niobium is an optional element and may be added to the steel of the present invention from 0.001% to 0.09%, preferably from 0.001% to 0.08% and more preferably from 0.01% to 0.07%. It is suitable for forming carbonitrides to impart strength to the steel according to the invention by precipitation hardening during the annealing soaking temperature range consequently after the complete annealing is finer, this leads to the hardening of the product. However, when the niobium content is above 0.09% niobium consumes carbon by forming large amounts of carbo-nitrides which is not favorable for the present invention as large amounts of carbo-nitrides tend to reduce the ductility of the steel as well as consumes carbon during the formation of carbo-nitrides which reduces the availability of carbon for the stabilization of Austenite.

Titanium is an optional element which may be added to the steel of the present invention from 0% to 0.06%, preferably from 0.001% to 0.03%. As niobium, it is involved in carbo-nitrides, so it plays a role in hardening. But it is also involved to form TiN appearing during solidification of the cast product. The amount of Ti is limited to 0.06% to avoid coarse TiN, which is detrimental for hole expansion. In case the titanium content is below 0.001% it does not impart any effect on the steel of the present invention.

Vanadium is an optional element which may be added to the steel of the present invention from 0% to 0.1%, preferably from 0.001% to 0.1%. As niobium, it is involved in carbo-nitrides, so it plays a role in hardening. But it is also involved to form VN appearing during solidification of the cast product. The amount of V is limited to 0.1% to avoid coarse VN detrimental for hole expansion. In case the vanadium content is below 0.001% it does not impart any effect on the steel of the present invention.

Molybdenum is an optional element that is present from 0% to 0.5% in the steel of the present invention. Molybdenum plays an effective role in improving hardenability and hardness, delays the formation of ferrite and bainite during the cooling after annealing, when added in an amount of at least 0.01%. Mo is also beneficial for the toughness of the hot rolled product resulting in easier manufacturing. However, the addition of Molybdenum excessively increases the cost of the addition of alloy elements, so for economic reasons its content is limited to 0.5%. The preferable limit for Molybdenum is from 0% to 0.4% and more preferably from 0% to 0.3%.

Nickel may be added as an optional element in an amount of 0% to 1% to increase the strength of the steel and to improve its toughness. A minimum of 0.01% is required to produce such effects. However, when its content is above 1%, Nickel causes ductility deterioration.

Copper may be added as an optional element in an amount of 0% to 1% to increase the strength of the steel and to improve its corrosion resistance. A minimum of 0.01% is required to produce such effects. However, when its content is above 1%, copper causes hot ductility deterioration during hot rolling.

Calcium is an optional element which may be added to the steel of the present invention from 0% to 0.005%, preferably from 0.001% to 0.005%. Calcium is added to steel of the present invention as an optional element especially during the inclusion treatment. Calcium contributes towards the refining of the steel by reducing the detrimental Sulfur content in globularizing it.

Boron is an optional element, which can be added from 0 to 0.010%, preferably from 0.001% to 0.004%, to harden the steel.

Other elements such as cerium, magnesium or zirconium can be added individually or in combination in the following proportions: Ce≤0.1%, Mg≤0.05% and Zr≤0.05%. Up to the maximum content levels indicated, these elements make it possible to refine the inclusion grain during solidification.

The remainder of the composition of the steel consists of iron and inevitable impurities resulting from processing.

The microstructure of the steel sheet according to the invention comprises a cumulative presence of 35% to 70% of Partitioned martensite and bainite, 9% to 15% of Residual Austenite, 12% to 38% of Ferrite, 5% to 15% of Fresh martensite by area fraction.

The surface fractions of phases in the microstructure are determined through the following method: a specimen is cut from the steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the fraction of ferrite is performed thanks to SEM observations after Nital or Picral/Nital reagent etching.

The determination of Residual Austenite is done by sigmametry and the determination of the bainite and partition martensite is done by image analysis.

The determination of the fractions of bainite, fresh martensite and partitioned martensite is being done by analysis of the images from the FEG-SEM.

Bainite and Partitioned Martensite forms the matrix of the steel and is contained in an amount of 35% to 70% to achieve the strength level of 1000 MPa or more. If the cumulated amount of bainite and partition martensite amount reaches beyond 70%, it would have detrimental impact on ductility. Partitioned martensite of the present steel can be in the form of laths wherein the lath thickness is higher than 0.1 micron. Martensite, that is formed during the cooling after annealing, is transformed into Partitioned martensite during the heating to the overaging temperature. In the frame of the present invention, bainite can comprise carbide-free bainite and/or lath bainite. When present, lath bainite is in form of laths of thickness from 1 micron to 5 microns. When present, carbide-free bainite is a bainite having a very low density of carbides, below 100 carbides per area unit of 100 μm² and possibly containing austenitic islands. Bainite provides an improved elongation. The preferred presence of the bainite and partitioned martensite for the steel of the present invention is from 40% to 68% and more preferably from 42% to 65%.

Residual Austenite is contained in an amount of 9% to 15% and imparts ductility to the present steel of the present invention. The retained austenite of the present invention preferably contains carbon more than 0.8%, and more preferably the carbon content is more than 0.9%. Austenite range allows to impart mechanical properties such as formability and elongation. In addition, austenite also imparts ductility to the present steel. The preferred range for Residual Austenite is from 10% to 14% and more preferably from 11% to 14%.

Ferrite constitutes from 12% to 38% of microstructure by area fraction for the Steel of the present invention. Ferrite imparts strength as well as elongation to the steel of the present invention. Ferrite of the present steel may comprise polygonal ferrite, lath ferrite, acicular ferrite, plate ferrite or epitaxial ferrite. To ensure an elongation of 14% and preferably 15% or more it is necessary to have 12% of Ferrite. Ferrite of the present invention is formed during annealing and cooling done after annealing. But whenever ferrite content is present above 38% in steel of the present invention it is not possible to have both yield strength and the total elongation at same time due to the fact that ferrite increases the gap in hardness with hard phases such as partition martensite and bainite and reduces local ductility, resulting in deterioration of total elongation and yield strength. The preferred limit for presence of ferrite for the present invention is from 14% to 36% and more preferably 15% to 35%.

Fresh Martensite constitutes from 5% to 15% of microstructure by area fraction. The present invention forms fresh martensite due to the cooling after overaging holding and may also form during cooling after the coating of cold rolled steel sheet. Fresh martensite imparts ductility and strength of the Steel of the present invention. However, when the fresh martensite presence is above 15% it imparts excess strength but diminishes the elongation beyond the acceptable limit for the steel of the present invention due to the reason that the Fresh martensite has the same amount of carbon content as the Residual Austenite hence the fresh martensite is brittle and hard. Preferred limit for martensite for the steel of the present invention is from 5% to 14% and more preferably from 8% to 13%.

In addition to the above-mentioned microstructure, the microstructure of the cold rolled steel sheet is free from microstructural components such as pearlite and cementite.

A cold rolled and coated steel sheet according to the invention can be produced by any suitable method. A preferred method consists of providing a semi-finished casting of steel with a chemical composition according to the invention. The casting can be done either into ingots or continuously in form of thin slabs or thin strips, i.e. with a thickness ranging from approximately 220 mm for slabs up to several tens of millimeters for thin strips.

For example, a slab will be considered a semi-finished product. A slab having the above-described chemical composition is manufactured by continuous casting wherein the slab preferably underwent a direct soft reduction during casting to ensure the elimination of central segregation and porosity reduction. The slab provided by the continuous casting process can be used directly at a high temperature after the continuous casting or may be first cooled to room temperature and then reheated for hot rolling.

The temperature of the slab which is subjected to hot rolling is preferably at least 1000° C., preferably above 1150° C. and must be below 1300° C. In case the temperature of the slab is lower than 1150° C., an excessive load is imposed on a rolling mill, and further, the temperature of the steel may decrease to a ferrite transformation temperature during finishing rolling, whereby the steel will be rolled in a state in which transformed ferrite contained in the structure. The temperature of the slab is preferably kept above 1150° C. to keep all the micro alloyed elements in a solid solution especially Niobium. Further, the temperature must not be above 1300° C. because that is industrially expensive.

The temperature of the slab is preferably sufficiently high so that hot rolling can be completed entirely in the austenitic range, the finishing hot rolling temperature remains greater than or equal 850° C. It is necessary that the final rolling be performed at least at 850° C., because below this temperature the steel sheet exhibits a significant drop in rollability.

The sheet obtained in this manner is then cooled at a cooling rate above 3° C./s to a temperature which is below or equal to 650° C. Preferably, the cooling rate will be less than or equal to 65° C./s and above 10° C./s. Thereafter the hot rolled steel sheet is coiled at a coiling temperature below 650° C. and preferably below 600° C. and more preferably below 575° C. Thereafter the coiled hot rolled steel sheet is allowed to cool down, preferably to room temperature. Then the hot rolled sheet may be subjected to on optional scale removal process such as pickling to remove scale formed during hot rolling and ensure that there is no scale on the surface of hot rolled steel sheet before subjecting it to an optional hot band annealing.

The hot rolled sheet is subjected to hot band annealing at a temperature from 350° C. to 750° C. during 1 to 96 hours. The temperature and time of such hot band annealing is selected to ensure softening of the hot rolled sheet to facilitate the cold rolling of the hot rolled steel sheet. Then the hot rolled sheet may be subjected to optional scale removal process such as pickling to remove scale formed during hot band annealing.

The hot rolled steel sheet is then cooled down to room temperature, thereafter, the hot rolled sheet is then cold rolled with a thickness reduction from 35 to 70% to obtain a cold rolled steel sheet.

The cold rolled steel sheet is then subjected to annealing to impart the steel of the present invention with targeted microstructure and mechanical properties.

In the annealing, the cold rolled steel sheet is subjected to heating wherein the cold rolled steel sheet is heated in a two steps heating process wherein the first step of heating starts from room temperature, the cold rolled steel sheet being heated, at a heating rate HR1 of at least 10° C./s, to a temperature HT1 which is in a range from 575° C. to 770° C. In a preferred embodiment, the heating rate HR1 for such first step of heating is at least 12° C./s and more preferably at least 13° C./s. The preferred HT1 temperature for such first step is from 600° C. to 760° C. and more preferably from 600° C. to 700° C.

In the second step of heating, the cold rolled steel sheet is heated from HT1 to an annealing temperature Tsoak which is from 780° C. to 880° C., preferably from 800° C. to 860° C., at a heating rate HR2 which is from 0.5° C./s to 50° C./s. In a preferred embodiment, the heating rate HR2 for the second step of heating is from 0.7° C./s to 25° C./s and more preferably 0.8° C./s and 20° C./s,

Then the cold rolled steel sheet is held at the annealing soaking temperature Tsoak during 100 to 1000 seconds to ensure adequate transformation to form at least 90% of Austenite at the end of the soaking.

The cold rolled steel sheet is then cooled in a two steps cooling process wherein the first step of cooling is optional and this first steps starts from Tsoak, the cold rolled steel sheet being cooled down, at a cooling rate CR1 from 0.1° C./s to 15° C./s, to a temperature T1 which is in a range from 680° C. to 820° C. In a preferred embodiment, the cooling rate CR1 for such first step of cooling is from 0.2° C./s to 5° C./s. The preferred T1 temperature for such first step is from 700° C. to 800° C.

In the second step of cooling, the cold rolled steel sheet is cooled from T1 or Tsoaking to a temperature T2 which is from Ms−10° C. to 20° C., at a cooling rate CR2 of at least 15° C./s. In a preferred embodiment, the cooling rate CR2 for the second step of cooling is at least 20° C./s and more preferably at least 25° C./s. The preferred T2 temperature for such second step is from 300° C. to 200° C. Whenever step one of cooling is not performed then T1 is equal to Tsoaking.

The steel may be optionally held at T2 for a time from 1 second to 200 seconds. During this step of cooling, martensite of the present invention is formed. If the T2 temperature is more than Ms−40° C. the steel of the present invention has too much Austenite which is detrimental for the total elongation and if the T2 is less than Ms−130° C. the amount of Residual Austenite is too low and the total elongation target is not achieved.

In a subsequent step the cold rolled steel sheet is heated to an overaging temperature range TOA from 350° C. to 550° C. from T2 temperature at a heating rate HR3 from 1° C./s to 100° C./s. The preferred TOA temperature is from 380° C. to 520° C. During the heating to TOA temperature and during holding at TOA temperature, martensite formed during cooling after annealing is transformed into partitioned martensite by rejecting the carbon which is consumed by austenite for its stabilization as residual austenite at room temperature. Still some amount of carbon from martensite remains in the partition martensite this carbon is present in the partition martensite in the form of precipitates. Simultaneously unstable austenite is also transforming into Cementite free bainite which also rejects carbon due the presence of silicon and thereby also aiding in stabilization of Residual Austenite. Then the cold rolled steel sheet is held at TOA temperature for over-aging during 5 to 500 seconds.

Then the cold rolled steel sheet is brought to the temperature of a hot dip coating bath, which can be from 420° C. to 680° C., depending on the nature of the coating. The coating can be made with zinc or a zinc-based alloy or with aluminum or with an aluminum-based alloy. Then the cold rolled steel sheet is cooled to room temperature to obtain a coated and cold rolled steel sheet.

### EXAMPLES

The following tests and examples presented herein are non-restricting in nature and must be considered for purposes of illustration only and will display the advantageous features of the present invention and expound the significance of the parameters chosen by inventors after extensive experiments and further establish the properties that can be achieved by the steel according to the invention.

Samples of the steel sheets according to the invention and to some comparative grades were prepared with the compositions gathered in table 1 and the processing parameters gathered in table 2. The corresponding microstructures of those steel sheets were gathered in table 3 and the properties in table 4.

Table 1 depicts the steels with the compositions expressed in percentages by weight:

TABLE 1
composition of the trials

| Trials | C | Mn | Si | Cr | Al | P | S | N | Ti | B |
|---|---|---|---|---|---|---|---|---|---|---|
| 11 | 0.205 | 2.225 | 1.510 | 0.200 | 0.035 | 0.015 | 0.0015 | 0.0037 | 0.007 | 0.0006 |
| 12 | 0.205 | 2.224 | 1.514 | 0.202 | 0.035 | 0.012 | 0.0013 | 0.0055 | 0.007 | 0.0005 |
| 13 | 0.203 | 2.210 | 1.507 | 0.205 | 0.033 | 0.013 | 0.0010 | 0.0054 | 0.008 | 0.0006 |
| 14 | 0.200 | 2.211 | 1.500 | 0.205 | 0.032 | 0.013 | 0.0006 | 0.0050 | 0.008 | 0.0006 |
| 15 | 0.200 | 2.211 | 1.500 | 0.205 | 0.032 | 0.013 | 0.0006 | 0.0050 | 0.008 | 0.0006 |
| R1 | 0.205 | 2.225 | 1.510 | 0.200 | 0.035 | 0.015 | 0.0015 | 0.0037 | 0.007 | 0.0006 |
| R2 | 0.204 | 2.228 | 1.508 | 0.197 | 0.038 | 0.014 | 0.0004 | 0.0028 | 0.009 | 0.0006 |

underlined values: not according to the invention

Table 2 gathers the annealing process parameters implemented on steels of Table 1.

Table 2 also shows Martensite transformation Ms temperatures of the inventive steel and the reference steel.

Ms was determined through dilatometry tests done as per the publication by S. M. C Van Bohemen and J. Siestma in Metallurguical and Materials Transaction in Volume 40A in May 2009 at page 1059-1068.

Further, before performing the annealing treatment on the steels of the present invention as well as reference, the samples were heated to a temperature of 1150° C. and then subjected to hot rolling with finishing temperature above 850° C. The cooling rate after hot rolling was 30° C./s until cooling down below 650° C. for coiling the hot rolled steel. Steels of all the trails were pickled before cold rolling and the cold rolling reduction for all the trials is 50% reduction. All cold rolled steel sheets were coated in a zinc bath at temperature 460° C. after the over aging holding.

TABLE 2
process parameters of the trials

HBA

| Trials | (° C.) | t (h) |
|---|---|---|
| I1 | 630 | 12 |
| I2 | 550 | 12 |
| I3 | 550 | 12 |
| I4 | 550 | 12 |
| I5 | 550 | 12 |
| R1 | 630 | 12 |
| R2 | 630 | 12 |

HBA : hot band annealing of steel sheet

| | Annealing | | | | | | | | | Overaging holding | | | |
|---|---|---|---|---|---|---|---|---|---|---|---|---|---|
| | HR1 | HT1 | HR2 | Tsoak | Soaking | CR1 | T1 | CR2 | T2 | HR3 | TOA | Time | |
| Trials | (° C./s) | (° C.) | (° C./s) | (° C.) | time (s) | (° C./s) | (° C.) | (° C./s) | (° C.) | (° C./s) | (° C.) | (s) | Ms |
| 11 | 17 | 735 | 1.8 | 835 | 246 | — | — | 29 | 239 | 14 | 439 | 124 | 366 |
| 12 | 15 | 750 | 1.8 | 830 | 116 | — | — | 57 | 274 | 13 | 457 | 59 | 366 |
| 13 | 15 | 700 | 1.9 | 825 | 149 | 1 | 800 | 46 | 250 | 11 | 431 | 75 | 368 |
| 14 | 20 | 660 | 2.7 | 826 | 220 | 1 | 755 | 29 | 214 | 15 | 450 | 111 | 369 |
| 15 | 17 | 672 | 1.9 | 827 | 204 | 1 | 757 | 32 | 215 | 13 | 441 | 103 | 369 |
| R1 | 15 | 732 | 3.1 | 850 | 136 | 1 | 832 | 48 | 280 | 13 | 480 | 69 | 366 |
| R2 | 15 | 700 | 2.3 | 855 | 154 | 1 | 825 | 42 | 280 | 11 | 473 | 77 | 367 |

I = according to the invention; R = reference; underlined values: not according to the invention.

Table 3 gathers the results of test conducted in accordance with the standards on different microscopes such as Scanning Electron Microscope for determining microstructural composition of both the inventive steel and reference trials.

TABLE 3

| | Partitioned | | | Fresh |
|---|---|---|---|---|
| | martensite + | Ferrite | Austenite | martensite |
| Trials | Bainite (%) | (%) | (%) | (%) |
| I1 | 51 | 28 | 12 | 9 |
| I2 | 63 | 15 | 11 | 11 |
| I3 | 59 | 24 | 11 | 6 |
| I4 | 48 | 33 | 13 | 6 |
| I5 | 46 | 33 | 13 | 8 |
| R1 | 77 | 4 | 11 | 8 |
| R2 | 17 | 40 | 8 | 35 |

I = according to the invention; R = reference; underlined values: not according to the invention.

It can be seen from the table above that the trials according to the invention all meet the microstructure targets.

Table 4 gathers the mechanical and surface properties of both the inventive steel and reference steel.

TABLE 4
mechanical properties of the trials

| Trials | TS (MPa) | YS (MPa) | Total elongation (%) | HER(%) |
|---|---|---|---|---|
| I1 | 1071 | 709 | 18.0 | 26 |
| I2 | 1126 | 823 | 15.6 | 37 |
| I3 | 1097 | 841 | 17.7 | 35 |
| I4 | 1057 | 765 | 17.9 | 36 |
| I5 | 1060 | 771 | 18.3 | 33 |
| R1 | 1159 | 1001 | 13.0 | 50 |
| R2 | 1103 | 649 | 16.1 | 11 |

The yield strength YS, the tensile strength TS and the total elongation TE are measured according to ISO standard ISO 6892-1, published in October 2009.
I = according to the invention; R = reference; underlined values: not according to the invention.

1-15. (canceled)

16. A cold rolled and coated steel sheet, the steel comprising, in weight percentage,
0.15%≤carbon≤0.25%,
1.5%≤manganese≤2.5%,
1%≤silicon≤2%,
0%≤aluminum≤0.09%,
0.1%≤chromium≤0.6%,
0%≤phosphorus≤0.02%,
0%≤sulfur≤0.03%,
0%≤nitrogen≤0.09%,
and optionally one or more of the following elements
0%≤molybdenum≤0.5%,
0.001%≤niobium≤0.09%,
0%≤titanium≤0.06%,
0%≤vanadium≤0.1%,
0%≤nickel≤1%,
0%≤Magnesium≤0.05%,
0%≤Zirconium≤0.05%,
0%≤Cerium≤0.1%,
and a balance including iron and unavoidable impurities,
the steel sheet having a microstructure comprising 35% to 70% of cumulative presence of Bainite and Partitioned Martensite, 9% to 15% of residual austenite, 12% to 38% of ferrite and 5% to 15% fresh martensite in area fractions.

17. The cold rolled and coated steel sheet as recited in claim 16 wherein the composition includes 1.7% to 2.3% of manganese.

18. The cold rolled and coated steel sheet as recited in claim 16 wherein the composition includes composition includes 0.17% to 0.23% of Carbon.

19. The cold rolled and coated steel sheet as recited in claim 16 wherein the composition includes composition includes 1.1% to 1.9% of Silicon.

20. The cold rolled and coated steel sheet as recited in claim 16 wherein the composition includes composition includes 0.001% to 0.08% of Niobium.

21. The cold rolled and coated steel sheet as recited in claim 16 wherein the microstructure contains a cumulative presence of bainite and Partitioned martensite from 40% to 68%.

22. The cold rolled and coated steel sheet as recited in claim 16 wherein the microstructure contains residual 10% to 14% of residual austenite.

23. The cold rolled and coated steel sheet as recited in claim 16 wherein the microstructure contains 14% to 36% of ferrite.

24. The cold rolled and coated steel sheet as recited in claim 16 wherein the steel sheet has a total elongation of 14% or more.

25. The cold rolled and coated steel sheet as recited in claim 16 wherein the steel sheet has a hole expansion ratio greater than or equal to 20%.

26. A method of manufacturing of a cold rolled and coated steel sheet comprising the following successive steps:
providing a steel composition comprising, in weight percentage,
0.15%≤carbon≤0.25%,
1.5%≤manganese≤2.5%,
1%≤silicon≤2%,
0%≤aluminum≤0.09%,
0.1%≤chromium≤0.6%,
0%≤phosphorus≤0.02%,
0%≤sulfur≤0.03%,
0%≤nitrogen≤0.09%,
and optionally one or more of the following elements
0%≤molybdenum≤0.5%,
0.001%≤niobium≤0.09%,
0%≤titanium≤0.06%,
0%≤vanadium≤0.1%,
0%≤nickel≤1%,
0%≤Copper≤1%,
0%≤calcium≤0.005%,
0%≤boron≤0.010%,
0%≤Magnesium≤0.05%,
0%≤Zirconium≤0.05%,
0%≤Cerium≤0.1%,
and a balance including iron and unavoidable impurities, to obtain a semi-finished product;
reheating the semi-finished product to a temperature above from 1000° C.;
rolling the semi-finished product completely in the austenitic range wherein the hot rolling finishing temperature is greater than or equal to 850° C. to obtain a hot rolled steel sheet;
cooling the sheet at a cooling rate above 3° C./s to a temperature below or equal to 650° C.; and coiling the hot rolled sheet at temperature of coiling below 650° C.;
cooling the hot rolled steel sheet;
performing optional scale removal process on the hot rolled steel sheet;
subjecting the hot rolled steel sheet to an annealing at a temperature from 350° C. to 750° C. during 1 h to 96 h;
performing optional scale removal process on the hot rolled annealed steel sheet;
cold rolling the hot rolled steel sheet with a reduction rate from 35 to 70% to obtain a cold rolled steel sheet;
then heating the said cold rolled steel sheet in a two step heating wherein:
a first step of heating the cold rolled steel sheet starts from room temperature to a temperature HT1 from 575° C. to 770° C., with a heating rate HR1 of at least 10° C./s;
a second step of heating starts from HT1 to a temperature Tsoak from 780 to 880° C., with a heating rate HR2 from 0.5° C./s to 50° C./s, and holding for 100 to 1000 seconds;
then cooling the cold rolled steel sheet wherein:
an optional first step of cooling the cold rolled steel sheet starts from Tsoak down to a temperature T1 from 680° C. to 820° C., with a cooling rate CR1 from 0.1° C./s to 15° C./s;
a cooling step starts from T1 or Tsoak down to a temperature T2 from Ms-10° C. to 20° C., with a cooling rate CR2 of at least 15° C./s, the cold rolled steel sheet optionally being held at T2 from 1 second to 200 seconds;
then heating the cold rolled steel sheet from T2 temperature to an overaging temperature TOA from 350° C. to 550° C. at an average heating rate HR3 from 1° C./s to 100° C./s;
then the said cold rolled steel sheet is overaged at TOA for 5 to 500 seconds;
then the cold rolled steel sheet is brought to coating temperature from 420° C. to 680° C. for coating the cold rolled steel sheet; and
thereafter cooling the coated cold rolled steel sheet to room temperature to obtain a cold rolled and coated steel sheet.

27. The method as recited in claim 26 wherein the Tsoak temperature is from 800° C. to 860° C.

28. The method as recited in claim 26 wherein the HT1 temperature is from 600° C. to 760° C.:

29. The method as recited in claim 26 wherein the TOA temperature is from 380° C. to 520° C.:

30. A method for manufacture of structural or safety parts of a vehicle comprising employing the method as recited in claim 26.

31. A method for manufacture of structural or safety parts of a vehicle comprising employing the cold rolled and coated steel sheet as recited in claim 16.
